(19) United States
(12) Patent Application Publication
(10) Pub. No.: US 2001/0016033 A1
(43) Pub. Date: Aug. 23, 2001

(54) Audio storage apparatus

(76) Inventor: Makoto Nakatsu, Fukuoka (JP)

Correspondence Address: McDERMOTT, WILL & EMERY, 600 13th Street, N.W., Washington, DC, 20005-3096, US

(21) Appl. No.: 09/741,157

(22) Filed: Dec. 21, 2000

(30) Foreign Application Priority Data
Dec. 24, 1999 (JP) 11-367198

(51) Int. Cl. H04M 1/64

(52) U.S. Cl. 379/67.1; 379/88.21

(57) ABSTRACT

An audio storage apparatus for reproducing response message corresponding to caller information. An audio storage stores audio data such as a response message. A caller information detector detects caller information incoming from a network. A message controller assigns each caller information with the response message. When calling in, the response message is reproduced on the basis of the mailbox designated by the caller and the caller information detected by the caller information detector. If there is a response message to a specific caller in an assigned mailbox, this response message is reproduced. For example, by registering in the mailbox on the basis of the caller information separated into an organization and an individual person, the response message can be used selectively for the individual person and the organization.

### FIELD OF THE INVENTION

The present invention relates to an audio storage apparatus connected to a network including an analog telephone line, a digital telephone line and an extension line connected to a private branch exchange, for recording and reproducing an audio message through the network.

### BACKGROUND OF THE INVENTION

In an audio storage apparatus for storing multiple audio messages such as voice mails, plural users have their individual mailboxes within the audio storage apparatus. A party (or caller) wishing to leave a message to a specific user specifies the mailbox of the specific user by a prescribed operation. Thus, the message is left in the mailbox.

Each mailbox is assigned with a response message preliminarily recorded by each user or a response message recorded before shipping the product. When the mailbox is specified, the response message of the specified mailbox is reproduced. Then the caller records an audio message in this mailbox.

Therefore, in this method, the response message in each mailbox is fixed. Therefore, the same response message is reproduced to any callers.

### SUMMARY OF THE INVENTION

It is hence an object of the invention to present an audio storage apparatus capable of changing the response message in the mailbox depending on the caller.

The audio storage apparatus of the invention comprises:

1) an audio storage unit for storing audio data,

2) an audio data controller for reading out the audio data stored in the audio storage unit,

3) a network interface for connecting with a network including telephone line and extension line of private branch exchange, and

4) a caller information detector for detecting caller information from an input signal incoming from the network.

Moreover, when this audio storage apparatus judges there is a request for hearing audio information on the basis of the incoming input signal through the network interface from the network, it reproduces the audio information corresponding to the caller information detected by the caller information detector by mans of the audio data controller.

In this structure, an appropriate audio information suited to the caller can be sent out. Therefore, this apparatus can satisfy the requirements of delivering different response messages to individual callers, depending on the callers as shown in the following examples.

i) A business response message is given to a certain caller.

ii) A private response message is given to other callers.

### BRIEF DESCRIPTION OF THE DRAWINGS

FIG. 1 is a block diagram showing an audio storage apparatus according to embodiment 1 of the invention.

FIG. 2 is a flowchart showing the hearing operation of the mailbox response message in the audio storage apparatus in FIG. 1.

FIG. 3A shows a control table of mailbox response message controller.

FIG. 3B shows a group control table registering plural extension numbers as one group.

FIG. 4 is a flowchart showing response message recording operation of the mailbox in the audio storage apparatus in FIG. 1.

### DESCRIPTION OF THE PREFERRED EMBODIMENT

A preferred embodiment of the invention is described below while referring to the accompanying drawings.

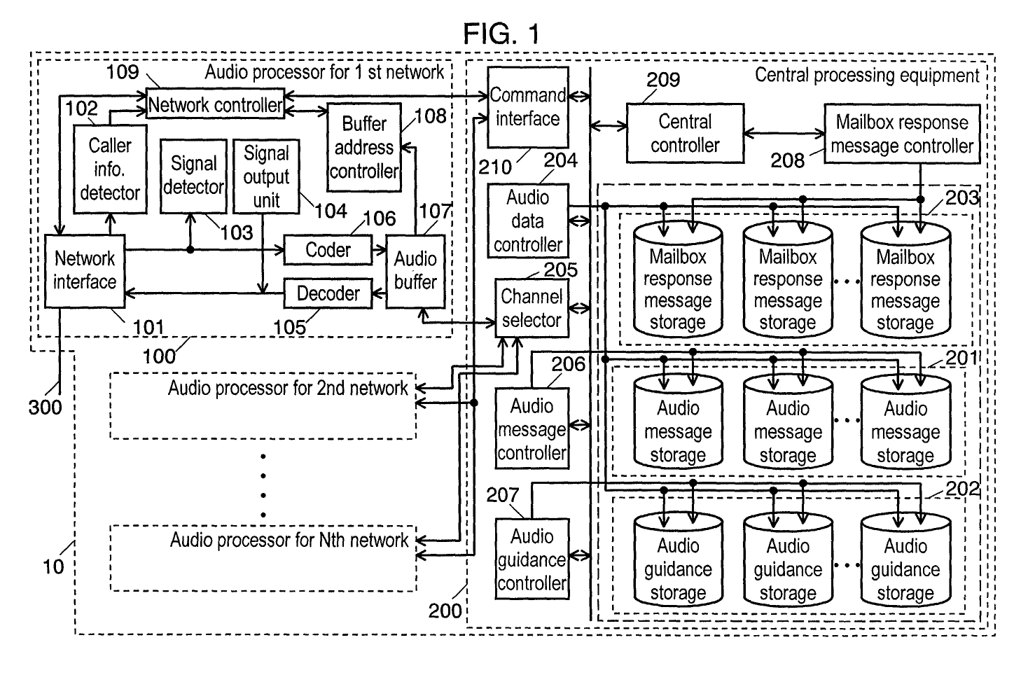

FIG. 1 is a block diagram showing an audio storage apparatus according to the embodiment of the invention.

In FIG. 1, an audio storage apparatus 10 comprises plural audio processors including an audio processor 100, and a central processing equipment 200.

The audio processor 100 exchanges data and audio messages with a network 300 including an analog or digital telephone line and an extension line of private branch exchange. The audio processor provided in each network 300 and the central processing equipment 200 control the audio message and the entire audio storage apparatus 10 for this purpose.

There are N pieces of audio processors in N pieces of networks including the network 300.

In the audio processor 100, each part functions as follows.

A network interface 101 connects with the network 300 and others. A caller information detector 102 detects caller information incoming from the network 300. A signal detector 103 detects an access signal to the audio storage apparatus 10 sent from the network 300 as dual tone multi-frequency (DTMF) signal or the like. A signal output unit 104 sends out the telephone number and various data to the network 300.

A decoder 105 converts a digital audio signal such as a pulse coded modulation (PCM) signal into an analog audio signal, and sends it to the network interface 101. A coder 106 converts the analog audio signal into the digital audio signal, and further sends out, as required, a compressed digital audio signal such as adaptive pulse coded modulation (ADPCM) signal.

An audio buffer 107 i) when recording the audio, stores temporarily the digital audio signal issued from the coder 106, and ii) when reproducing the message or the like, stores temporarily the digital audio signal to be entered into the decoder 105.

A buffer address controller 108 controls the read and write address of the audio buffer 107. A network controller 109 controls the entire audio processor 100 while exchanging information with the central processing equipment 200.

The audio processor 100 is responsible for audio processing of one network, and the entire audio storage apparatus 10 comprises plural audio processors as mentioned above.

In the central processing equipment 200 in FIG. 1, each part functions as follows.

Audio message storage 201 stores the digital audio signal stored in the audio buffer 107.

Audio guidance storage 202 stores the pre-recorded audio guidance (called main guidance).

Mailbox response message storage 203 stores the pre-recorded response message of each mailbox.

An audio data controller 204 reads out digital audio signals from the audio guidance storage 202, audio message storage 201, and mailbox response message storage 203, and stores the digital audio signals from the audio buffer 107 in the storage 203.

A channel selector 205 selects a network for input and output of audio from plural networks, and connects the audio buffer 107 to the audio data controller 204.

An audio message controller 206 controls the storage position of recorded or reproduced message in the audio message storage 201, and the information accompanying the audio message.

An audio guidance controller 207 controls the storage position of the audio guidance and the information accompanying the audio guidance in the audio guidance storage 202.

A mailbox response message controller 208 controls the storage position of response messages of plural mailboxes in the mailbox response message storage 203, and the information accompanying the response message in each mailbox and caller information.

A central controller 209 selects proper audio message storage 201, audio guidance storage 202, and mailbox response message storage 203 while exchanging information with the audio processor connected to each network, and records or reproduces audio data.

A command interface 210 exchanges command and status information with the central controller 209, network controller 109, and network controllers of other audio processors.

The audio message storage 201, audio guidance storage 202, and mailbox response message storage 203 make up the audio storage 220.

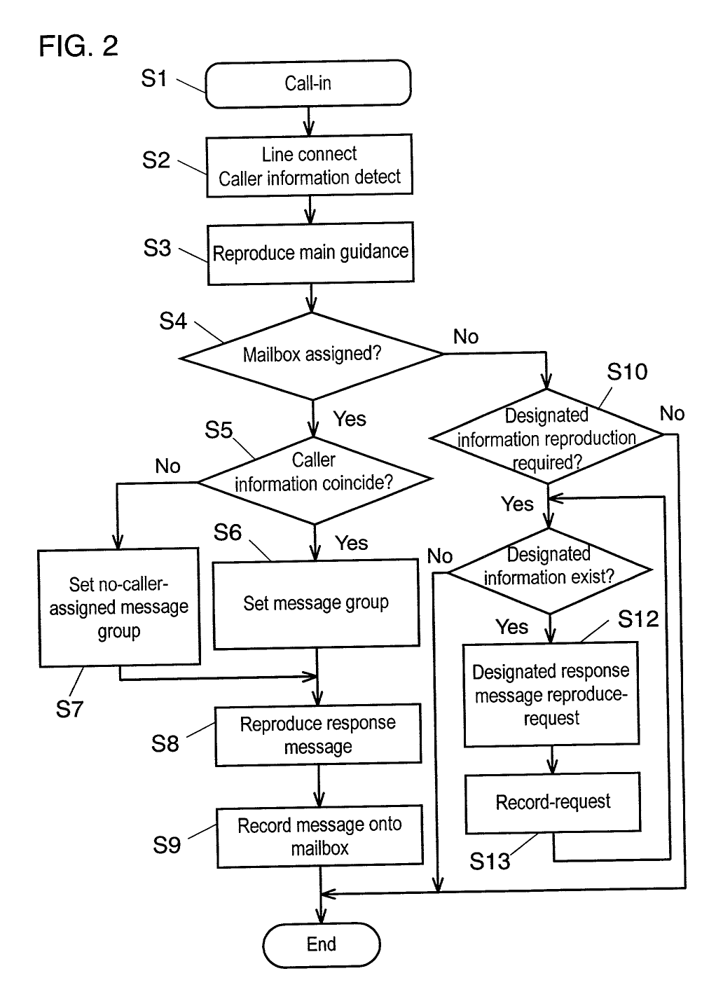

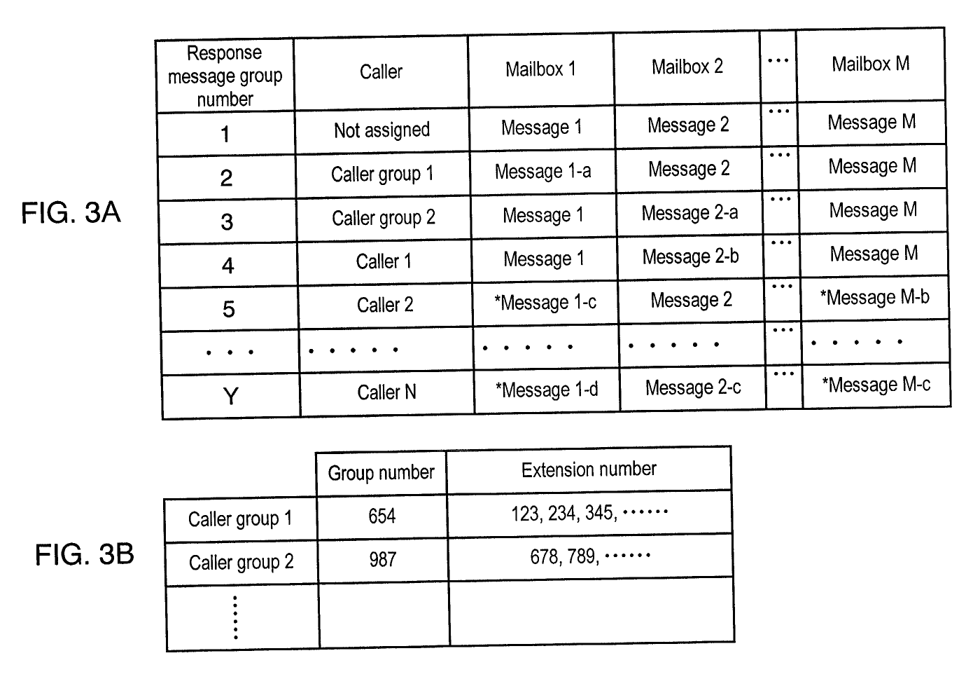

In thus composed audio storage apparatus 10, the hearing operation of mailbox response message is explained by referring to FIG. 2 and FIG. 3.

FIG. 2 is a flowchart showing the hearing operation of mailbox response message in the audio storage apparatus 10 in FIG. 1.

FIG. 3A shows a response message control table of the mailbox response message controller 208.

In FIG. 2, the network 300 calls in the audio storage apparatus 10 (S1).

Then, the network controller 109 connects to the network 300 through the network interface 101. At this time, when the caller information has been sent from the network 300, the information is taken into the caller information detector 102 (S2).

Herein, the caller information is sent in as follows.

i) Caller ID or information of “number display” function is sent from the exchange.

ii) Caller side information is sent from the private branch exchange through the telephone line or the control line to the audio storage apparatus 10.

After connection with the network 300, the central controller 209 controls to send the audio guidance, that is, the main guidance (for example, “This is the message center. Please enter your mailbox number.”) to the network interface 101 through the audio guidance controller 207 (S3).

Consequently, the central controller 209 judges if the caller hearing this audio guidance (main guidance) has assigned a desired mailbox number or not (S4).

Herein, the caller assigns a mailbox number by operating the keys of the own telephone set, and sending out DTMF or other signal to the network interface 101.

For example, when the caller sends information “1” assigning mailbox 1, this information is sent to the audio storage apparatus 10.

When it is judged that the mailbox number has been assigned, the central controller 209 refers to the control table of the mailbox response message controller 208 as shown in FIG. 3A. Next, the central controller 209 judges if any one of the response message groups “1” to “Y” of the mailbox corresponding to the caller information coincides with the caller information according to the caller information (information showing the category of callers) detected by the caller information detector 102 (S5).

When it is judged if any one of the response message groups coincides with the caller information, the central controller 209 sets the response message group number corresponding to the coinciding caller information (S6).

For example, if the caller information incoming from the network 300 is from “caller 1”, the corresponding response message group number “4” is set.

Herein, the caller information is designated by including the following cases.

i) Different information is included in each caller, such as caller number and caller name incoming from the network 300.

ii) Plural callers use the same caller number or caller name.

If none of the response message groups coincides with the incoming caller information, or if caller information is not incoming from the network 300, a response message group number corresponding to a case that no caller category is assigned by caller information is set from the response message groups of mailbox (S7).

In FIG. 3A, the response message group number “1” corresponding to “no assignment” is selected from the caller category indicated by the caller information of the control table of the mailbox response message controller 208.

Thus, after the response message group number is set, the response message of the assigned mailbox is reproduced from the set response message group number (S8).

In this case, when the “mailbox 1” is assigned by the caller and the response message group number “4” is set according to the caller information, “Message 1” is reproduced in the example in FIG. 3A.

More specifically, the response message of mailbox is reproduced as follows.

The audio data controller 204 reads out the audio data from the assigned mailbox response message storage 203, and sends out the data to the channel selector 205.

In an example of reproduction of response message, when the response message group number “5” is set on the basis of the caller information, and the “mailbox 1” is assigned, the response message is reproduced as in “Message 1-c” (for example, “This is Company A of trademark B. Please leave your message.”).

Or, when the response message group number “1” is set on the basis of the caller information, and the “mailbox 1” is assigned, the response message is reproduced as in Message 1 (for example, “This is Mr. A of Company B. Now I am out of office. Please leave a message after a beep tone.”).

In this way, the message varies corresponding to the caller information.

After reproduction of the response message, the caller records into the mailbox in order to record an audio message (S9).

To record into the mailbox, the audio message is stored in the memory position designated in the assigned mailbox response message storage 203 through the channel selector 205 and audio data controller 204.

In FIG. 2, suppose the central controller 209 judges that reproduction of specific audio information is designated, instead of assignment of mailbox number (S10).

On the basis of the caller information taken in, reproduction request and reproduction of response message group preliminarily designated as specific audio information, from the corresponding response message number groups, and recording request and recording into mailbox are executed sequentially until all the designated response message groups are completed (S11 to S13).

Herein, the specific audio information is an absence message or other information, prepared separately from the response message, for sending to a specific caller, or publicity information to be disclosed to specific caller group only.

For example, when the network 300 is assigned with the response message group number “Y”, the response message with “*” mark (meaning as being designated preliminarily as specific audio information) among the response message group, such as Message 1-d in mailbox 1 (for example, “Mr. A, what shall we do about that particular matter?”), or response message such as Message M-c in mailbox M (for example, “I am on business trip this week. If you would like to contact me, please call the following phone number.”) will be sequentially reproduced, and the recording of mailbox is requested.

Although not described in the flowchart in FIG. 2, suppose that the caller information is detected, the response message in the mailbox corresponding to the caller information is given, and there is information designated as specific audio information. At this time, before the start of main guidance, inquiry whether or not to reproduce the response message is sent out to the caller. Thus, the response message can be reproduced.

Besides, as shown in response message group number “2” or “3” in FIG. 3A, plural caller numbers can be set as a group and assigned as the caller. In the mailbox response message controller, the group control table registering plural extension numbers as one group is provided. FIG. 3B shows a group control table.

When “caller 1” (at the extension number “123”) and “caller 2” (at the extension number “234”) are assigned as a group, the response message of this group is reproduced whether the caller information of “caller 1” or “caller 2” comes in.

Suppose there are a single caller (for example, “caller 1”) and a group (for example, “group 1” incorporating “caller 1” and “caller 2”: group number “654”). At this time, it can be set as follows when caller information “123” of “caller 1” comes in.

i) Either the response message assigned to “caller 1” or the response message assigned to “group 1” is reproduced.

ii) Both the response message assigned to “caller 1” and the response message assigned to “group 1” are reproduced.

Thus, the audio storage apparatus of the invention is capable of:

1) Sending out adequate audio information depending on the caller;

2) Sending out adequate audio information depending on the caller group;

3) Using the response message for an individual person and for an organization separately, by registering them into one mailbox according to the caller information separated into a company or an organization, and the individual person; and

4) Reproducing the response message without assigning mailbox when there is mailbox response message as the specific audio information corresponding to the caller information.

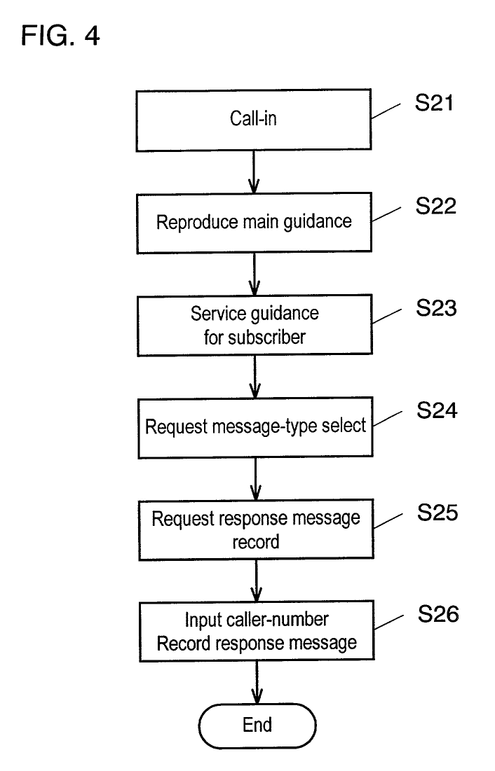

Next, the user's operation for recording response message in the mailbox in the audio storage apparatus 10 in FIG. 1 is explained by referring to FIG. 4.

FIG. 4 is a flowchart showing response message recording operation of the mailbox in the audio storage apparatus 10 in FIG. 1.

In FIG. 4, the user calls the audio storage apparatus 10, and calls in the audio storage apparatus 10 (S21).

At this time, the network controller 109 connects to the network 300 through the network interface 101.

As a result, the main guidance (for example, “This is message center. To specify mailbox, enter mailbox number. To designate subscriber service guide, enter “#” key.”) is sent out to the user (S22).

The user sends the information “#” for designating the subscriber service guide. According to this information, the guidance of the subscriber service guide (For example, “This is your subscriber service guide. To request a reproduction of message to your mailbox, enter “1”, and to record your response message of mailbox, enter “2”.”) is sent out to the user (S23).

The user sends information “2” for designating recording of response message of mailbox. According to this information, the guidance of response message recording of mailbox (for example, “You can record response message of mailbox. Enter “1” in the case of ordinary mailbox response message, or enter 2 in the case of response message for caller information.”) is sent to the user (S24).

When the user sends information “2” for designating a response message for caller information, according to this information, the guidance of response message recording the guide (for example, “Enter caller number, and then record response message.”) is sent out to the user (S25).

According to the guidance, the user enters the caller number. The user of the extension line enters, for example, caller number “1”, “2”, “3”, and after input of caller number, enters the response message. The caller number and response message are sent to the audio storage apparatus 10 through the network (S26).

Incidentally, plural callers can be assembled in one caller group by entering a group number according to the main guidance before or after input of response message. For example, if the group number is “987”, the user enters group number “9”, “8”, “7” at the step S26. This information is sent to the audio storage apparatus 10 through the network. Then the user enters the response message, and the audio of the response message is sent to the audio storage apparatus 10.

The above explanation relates to recording of response message. When recording specific audio information (for example, an absence message to be sent to a specific caller only, or publicity information to be disclosed to a specific caller group only), the procedure of recording is nearly the same.

In this case, when entering the caller number, add “*” mark before number, and enter, for example, in the sequence of “*”, “1”, “2”, and “3”, and this information is sent to the audio storage apparatus 10 through the network. After input of caller number, the user enters the audio message, and this audio message is sent to the audio storage apparatus 10 as specific audio information, and is registered.

Further, the mailbox response message controller 208 includes the response message having information of plural callers assigned as one group.

Thus, the specific audio information can be set and reproduced at once in a group of plural callers only. Then, it is not required to assign the individual callers with response message.

In this embodiment, the caller number is used as the caller information, but the invention is not limited to this example, and the name or ID of the caller may be used similarly.

According to the embodiment, in this audio storage apparatus, when calling in the network interface 101 from the network 300, the central controller 209 allows the audio data controller 204 to reproduce the main guidance stored in the audio guidance storage 202 contained in the audio storage. On the basis of the incoming input signal, when it is judged there is a request of hearing of response message of mailbox, this audio storage apparatus reproduces the response message corresponding to the caller information detected by the caller information detector 102 through the audio data controller 204.

When calling in the audio storage apparatus 10, an assignment of the mailbox is guided by the main guidance. Afterwards, when the caller assigns the mailbox, if there is response message of mailbox for the caller in the assigned mailbox, this response message can be reproduced. Therefore, by registering in one mailbox on the basis of the caller information classified into a company or an organization, and an individual person, the response message can be used selectively for the individual person and for the organization.

2) Moreover, this audio storage apparatus reproduces one or more pieces of specific audio information specifically assigned to the caller information detected by the caller information detector 102 through the audio data controller 204.

Thus, if there is any specific audio information for a certain specific caller, such caller can reproduce the specific audio information without assigning the mailbox.

In this case, by recording the specific audio information in relation to the caller information, and setting to reproduce the audio information without assigning the mailbox, the caller can hear the audio information without assigning the mailbox. Therefore, the probability of delivering the audio information to the caller is increased.

What is claimed is:

1. An audio storage apparatus comprising:
a) an audio storage unit for storing audio data,
b) an audio data controller for reading out the audio data stored in said audio storage unit,
c) a central controller for controlling said audio storage apparatus,
d) a network interface for connecting said audio storage apparatus to a network including a telephone line and an extension line, and
e) a caller information detector for detecting caller information from an input signal incoming from the network,
wherein audio information corresponding to the caller information is reproduced.

2. The audio storage apparatus of claim 1,
wherein said central controller reproduces the audio information corresponding to the caller information through the audio data controller when it is judged there is a request for hearing of audio information on the basis of the input signal.

3. The audio storage apparatus of claim 1, further comprising:
f) a group control table registering plural telephone numbers in one group,
wherein said central controller i) when calling in the network interface from the network, reproduces the main guidance stored in the audio storage through the audio data controller, and
ii) when judged there is a request for hearing of an audio message on the basis of the input signal, refers to the group control table, and when the caller information belongs to a specific group, reproduces the audio information depending on said group through the audio data controller.

4. The audio storage apparatus of claim 1, further comprising:
f) a response message control table for assigning each caller information with a response message of each mailbox, and
g) a group control table registering plural telephone numbers in one group,
wherein said audio storage further stores main guidance, and said central controller
1) when calling in the network interface from the network, reproduces the main guidance through the audio data controller,
2) when judged there is a request for hearing of the response message on the basis of the input signal,
i) reproduces the response message corresponding to the caller information through the audio data controller, and
ii) if the caller information belongs to a specific group by referring to the group control table, reproduces the audio information corresponding to the group through the audio data controller.

5. The audio storage apparatus of claim 1, further comprising:
f) a response message control table for assigning each caller information with a response message of each mailbox,
wherein said audio storage further stores main guidance, and said central controller
1) when calling in the network interface from the network, reproduces the main guidance through the audio data controller, and
2) when judged there is a request for hearing of a response message on the basis of the input signal, reproduces the response message corresponding to the caller information through the audio data controller.

6. The audio storage apparatus of claim 1, further comprising:
f) a mailbox response message controller for assigning each caller information with response message of each mailbox,
wherein said audio storage further stores main guidance, and said central controller
1) when calling in the network interface from the network, reproduces the main guidance through the audio data controller, and
2) when judged there is a request for hearing of audio information on the basis of the input signal, reproduces the designated response message assigned to the caller information through the audio data controller.

7. The audio storage apparatus of claim 5,
wherein said mailbox response message control table includes a response message assigned to a group of plural pieces of caller information.

8. The audio storage apparatus of claim 6,
wherein said mailbox response message controller stores the response message assigned to a group of plural pieces of caller information.

9. The audio storage apparatus of claim 6,
wherein the designated message is reproduced without an assignment of a mailbox.
